(19) United States
(12) Patent Application Publication
(10) Pub. No.: US 2013/0275461 A1
(43) Pub. Date: Oct. 17, 2013

(54) Computer-Implemented Systems and Methods for Identifying Factual Information in a Written Document

(71) Applicant: EDUCATIONAL TESTING SERVICE, Princeton, NJ (US)

(72) Inventors: Beata Beigman Klebanov, Hamilton, NJ (US); Derrick Higgins, Philadelphia, PA (US)

(73) Assignee: EDUCATIONAL TESTING SERVICE, Princeton, NJ (US)

(21) Appl. No.: 13/795,126

(22) Filed: Mar. 12, 2013

Related U.S. Application Data
(60) Provisional application No. 61/622,819, filed on Apr. 11, 2012.

(51) Int. Cl. G06F 17/30

(52) U.S. Cl. CPC G06F 17/30389
USPC 707/769

(57) ABSTRACT

Systems and methods are provided for identifying factual information in a written document. Named entities and corresponding noun phrases are identified in the written document. A query is built by combining one of the named entities with a respective one of the noun phrases. The query represents an assertion of a potential fact. The query is submitted for comparison with a fact repository which assesses whether the query presents a factual assertion. If the query presents a factual assertion (e.g., it matches a fact within the fact repository), a match is returned. Various modifications may be made to the queries to return additional matches and various combinations of filters may be applied to the matches to filter out less relevant matches.

### CROSS-REFERENCE TO RELATED APPLICATIONS

This application claims the benefit of U.S. Provisional Application No. 61/622,819 filed on Apr. 11, 2012, the entire contents of which is incorporated herein by reference.

### TECHNICAL FIELD

This document relates generally to identifying factual information and more particularly to computer implemented systems and methods for identifying factual information in a written document.

### BACKGROUND

Automated scoring of essays involves evaluating various aspects of the essay itself including, the grammar, usage, mechanics, organization and substantive content. For assessment of content, the focus has traditionally been on the topical appropriateness of the vocabulary. Recently, other aspects such as detection of sentiment or figurative language have also been considered. Although it is well known that a misleading premise, insufficient factual basis or an example that contradicts the reader's knowledge all detract from the quality of an essay, the effect that factual information in an essay has on the overall quality of the essay has not been addressed. It is believed that the use of factual information in an essay is correlated to the overall quality of the essay. Accordingly, identification and verification of factual information is important in a variety of contexts, including the scoring of essays and the like.

### SUMMARY

In accordance with the teachings herein, systems and methods are provided for identifying factual information in a written document. For example, a computer implemented method for identifying factual information in a written document may include identifying one or more named entities in the written document and identifying one or more noun phrases in the written document that are associated with a corresponding one or more named entity. Using a noun entity and a noun phrase, at least one query may be built by combining the named entity with a respective noun phrase. Since it is unknown at this stage whether the query corresponds to a fact, the query corresponds to an assertion—i.e., a statement that is believed to correspond to a fact but has not been verified as a fact. The query is submitted for comparison with a fact repository and an assessment is made as to whether the query presents a factual assertion—i.e., whether the assertion represented in the query is present in the fact repository. If it is present, a match is returned.

As another example, a system for identifying factual information in a written document may include one or more data processors and one or more computer readable mediums encoded with instructions for commanding the one or more data processors to perform processing steps. In the steps, one or more named entities in the written document may be identified and one or more noun phrases in the written document that are associated with a corresponding one or more named entity may also be identified. Using a noun entity and a noun phrase, at least one query may be built by combining the named entity with a respective noun phrase. Since it is unknown at this stage whether the query corresponds to a fact, the query corresponds to an assertion—i.e., a statement that is believed to correspond to a fact but has not been verified as a fact. The query is submitted for comparison with a fact repository and an assessment is made as to whether the query presents a factual assertion—i.e., whether the assertion represented in the query is present in the fact repository. If it is present, a match is returned.

As a further example, a computer readable medium may be encoded with instructions for commanding one or more data processors to perform processing steps. In the steps, one or more named entities in the written document may be identified and one or more noun phrases in the written document that are associated with a corresponding one or more named entity may also be identified. Using a noun entity and a noun phrase, at least one query may be built by combining the named entity with a respective noun phrase. Since it is unknown at this stage whether the query corresponds to a fact, the query corresponds to an assertion—i.e., a statement that is believed to correspond to a fact but has not been verified as a fact. The query is submitted for comparison with a fact repository and an assessment is made as to whether the query presents a factual assertion—i.e., whether the assertion represented in the query is present in the fact repository. If it is present, a match is returned.

In still further examples, noun phrase may be identified from the same sentence as the corresponding named entity and/or the noun phrase may by identified from a neighboring sentence to the named entity. For example, the noun phrase may be identified from a neighboring sentence if the corresponding named entity is a person and the neighboring sentence, from which the noun phrase is identified, includes at least one of an appropriate personal pronoun or a portion of the named entity.

In still further examples, the noun phrases may be identified using a dependency path of sentence structure. For example, the dependency path may be an upward step followed by between one and four downward steps (e.g., 1, 2, 3, or 4 downward steps).

In still further examples, the process may further comprise building variants of the query. For example, the variant of the query may be constructed by modifying the noun phrase. For example, a variant may be created by the removal of determiners and/or pre-modifiers from the noun phrase. A variant may be created by modifying the noun phrase to only include a sequence of nouns ending with the head noun. Another variant may be a noun phrase that is modified such that it comprises only the word from the identified noun phrase that has the lowest frequency of occurrence. A further example of a variant includes a noun phrase that is modified such that it comprises only the rightmost capitalized word of the identified noun phrase, if the identified noun phrase includes capitalized parts.

In still further examples, the process may further comprise filtering matches to eliminate undesired matches. For example, the match may be filtered if the matched noun phrase in the fact repository comprises modal or hedged predicates. Additionally, the match may be filtered if the named entity or the noun phrase in the fact repository is more specific than the named entity or the noun phrase in the query. In a further example, the match may be filtered if any of a plurality of conditions are met. Such conditions may include, for example: (i) if a capitalized word follows the named entity or noun phrase in the fact repository but is not present in the portion of the written document from which the named entity or noun phrase are identified; (ii) if more than one capitalized or rare words precedes the named entity or noun phrase in the fact repository but is not present in the portion of the written document from which the named entity or noun phrase are identified and the capitalized or rare words are not honorifics; (iii) if the named entity or noun phrase in the fact repository is longer than eight words; or (iv) if more than three words follow the named entity or noun phrase in the fact repository. Additionally, the match may be filtered if the ratio of negative to positive predicates among a plurality of matches is greater than a predetermined threshold.

### BRIEF DESCRIPTION OF THE FIGURES

FIG. 1 is a flow diagram illustrating an example of a method for identifying factual information in written documents;

FIG. 2 is a flow diagram illustrating another example of a method for identifying factual information in written documents;

FIG. 3 is a flow diagram illustrating another example of a method for identifying factual information in written documents; and

FIGS. 4A, 4B, and 4C are block diagrams illustrating an example systems for use in identifying factual information in written documents.

### DETAILED DESCRIPTION

As discussed above, identification and verification of factual information may be important in a variety of contexts including the scoring of essays and the like. A fact can be understood in a number of different manners. For example, in the context of argumentation (e.g., an argumentative essay) the notion of a fact may be characterized as data which is common to several beings and for which there is agreement as to the correctness of that data. In some examples, a fact can be distinguished from a presumption which may be a statement about what is normal and/or likely. In particular, this distinction in the scope of required agreement may be related to the referential device used in a particular statement. If the reference is more rigid, that is, less prone to change in time and to indeterminacy of the boundaries, the scope of necessary agreement is likely to by more precise. For example, statements made in connection with proper names may be more rigid than others (e.g., “Barack Obama” selects for one, and the same, person in 2010 and 1990 but “current U.S. president” selects for different people at different times).

In addition to identification of facts, it is also important to be able to verify that the identified statements are actually true. As discussed throughout this disclosure, the identified statements may be compared against a fact repository. For example, the fact repository may be an encyclopedia, the world wide web, based on Open Information Extraction (OIE), and/or the TextRunner system.

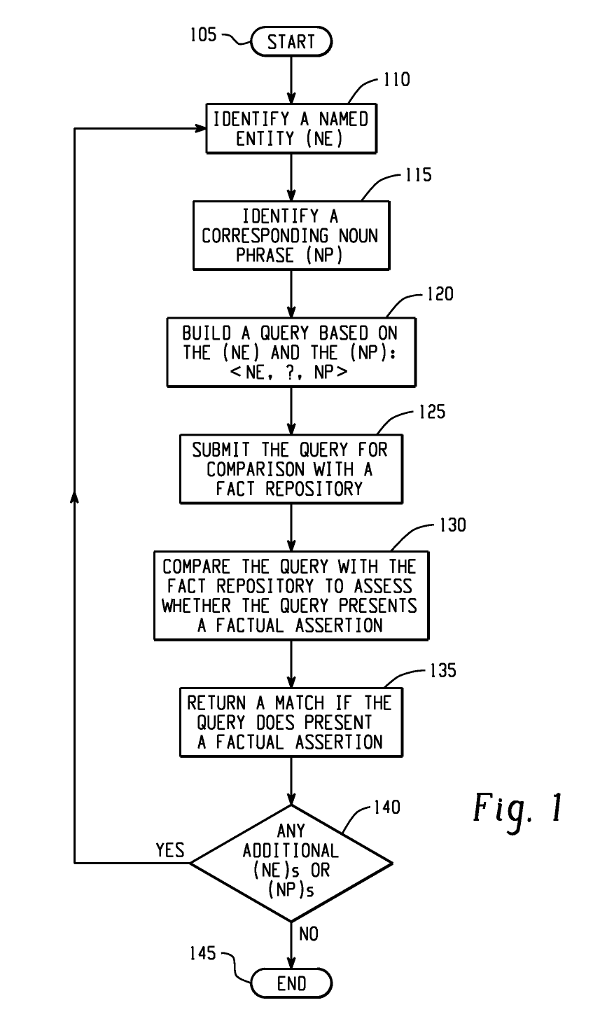

FIG. 1 is a flow diagram illustrating an example of a method for identifying factual information in written documents. As shown in FIG. 1, the process begins 105 with identifying a named entity (NE) 110. For example, the named entity may comprise at least one of people, proper names, locations, organizations, government, awards, events, science and technology, and/or art. In general, the named entity may be the subject of a particular statement or sentence or the argument of the predicate of a sentence. In an example, the named entity may be identified from a written document by comparing the words and/or phrases in the written document with named entities contained within an existing set of data. For example, the named entities may are identified using the Stanford Named Entity Recognizer.

In addition to identifying a named entity 110, the process continues with the identification of a corresponding noun phrase (NP) 115. A noun phrase is generally a word or phrase which includes a noun and the modifiers which distinguish it. Selection of the noun phrase may be based on, for example, a grammar-based approach. For example, noun phrase may be identified using a dependency path. In an example, the dependency paths may be obtained from the Stanford Dependency Parser. In particular, the dependency path may be an upward step followed by between one and four downward steps. For example, the it is believed that the most prolific family of paths starts with an upward step and then between 1-4 downward steps. The first upward step may connect the named entity to the predicate of which it is an argument. The downward step(s) may connect the predicate to the head of another argument (e.g., noun phrase) or to an argument's head's modifier. Some examples of statements with different dependency paths include: “a Nobel Prize in a science field” (one downward step); “Chaucer, in the 14th century . . . ” (one downward step); “the prestige of the Nobel Prize” (one upward step); “Kidman's talent” (one upward step); “Kroemer received the Nobel Prize” (one upward step followed by one downward step); and “Kroemer received the Nobel Prize for his work on the Heterojunction Bipolar Transistor” (one upward step followed by two downward steps).

In an example, the noun phrase may be contained within the same sentence as the corresponding named entity or it may be located in a neighboring sentence to the one with the named entity. For example, the noun phrase may be identified from a neighboring sentence if the corresponding named entity is a person and/or the neighboring sentence includes at least one of an appropriate personal pronoun and/or a portion of the named entity (e.g., just a last name of a person). In an example, the process may confirm that the gender of the pronoun matches that of the named entity and/or if the gender of the named entity cannot be confirmed, the process may not expand identification of the noun phrase into a neighboring sentence.

In an example, the written document that the named entity and noun phrase are identified from is e.g., a test taker's essay and/or the identification of factual information is utilized in the scoring of the test taker's essay.

The named entity and the noun phrase are used to build a query 120. For example, the query may be structured as a 3-tuple query. For example, the structure of the query may be <NE, ?, NP>. In examples, the “?” may be the predicate that links the named entity with the noun phrase.

The query is submitted for comparison to a fact repository 125. For example, the fact repository may be an encyclopedia, the world wide web, based on Open Information Extraction (OIE), and/or the TextRunner system. The comparison of the query with the fact repository assesses whether the query presents a factual assertion 130. In particular, the query is built with the belief that the assertion is factual but it is unknown whether the assertion is actually true. By comparing the query to the fact repository, the process determines whether there is a match within a data set that is believed to contain facts. If the query does match corresponding information within the fact repository, a match is returned 135. For example, the match may require that the fact repository contain a corresponding named entity and noun phrase to the ones in the query. In another example, the named entity may need to be contained within the fact repository but the noun phrase may not need to be exactly present. In another example, neither the named entity of the noun phrase in the fact repository would need to be exactly matched to the query as long at some predetermined criteria is met. In yet another example, the predicate in the query may or may not need to be matched.

After completing the matching process for the identified named entity and corresponding noun phrase, the process determines whether there are any additional named entities and/or noun phrases 140. If there are, the process begins again and if there are not, the process terminates 145.

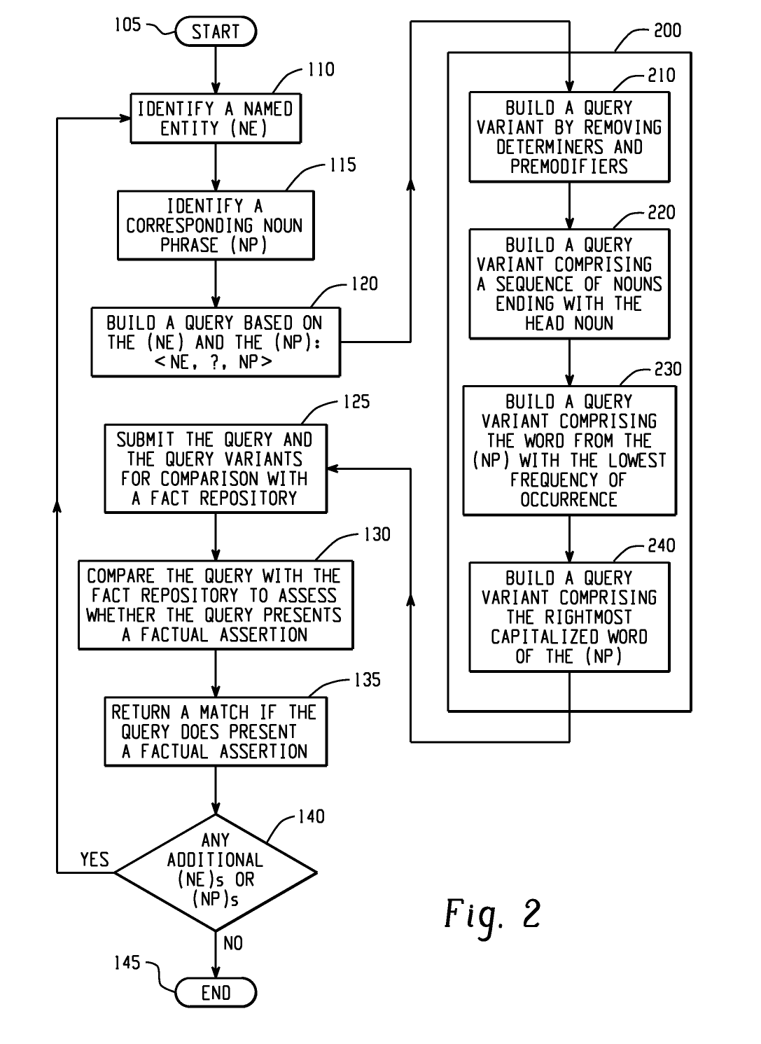

FIG. 2 is a flow diagram illustrating another example of a method for identifying factual information in written documents. FIG. 2 is similar to the example illustrated in FIG. 1 except that an additional series of steps 200 are included to create variants of the query built at 125. In the example illustrated in FIG. 2, the variants are built 200 before submitting any queries for comparison to the fact repository. In other example, the variants may be created after the initial query is submitted and then individually or collectively submitted for comparison with the fact repository.

As illustrated in FIG. 2, numerous variants of the query may be created by for example, modifying the noun phrase. The variants may assist in increasing the chances of finding a match for a particular named entity and noun phrase. In an example, one way a query may be modified is to remove determiners and/or pre-modifiers 210. For example, if the noun phrase was “a very beautiful photograph,” the modified phrase may be “beautiful photograph.”

In another example, the noun phrase can be modified to create a query variant that comprises a sequence of nouns ending with the head noun 220. For example, using the same example above, the noun phrase may be modified to “photograph.”

In another example, the noun phrase can be modified to create a query variant that comprises only the word from the noun phrase that has the lowest frequency of occurrence. For example, capitalized words may be given the lowest frequency so that if the noun phrase contained any capitalized word the variant might contain the left most capitalized word (e.g., the first capitalized word) or if an out of vocabulary word was present in the noun phrase, the out of vocabulary word. Accordingly, in an example, if the noun phrase contained a name, the name may be split such that only the first name is taken in the variant. For example, in the noun phrase “that author Orhan Phamuk” the variant noun phrase may be “Orhan.” If no capitalized word exists, the variant may simply select the rarest word from within the phrase. For example, if the noun phrase was “category 3 hurricane” the variant noun phrase may be “hurricane.”

In another example, the noun phrase can be modified to create a query variant that comprises only the rightmost capitalized word, if the noun phrase includes capitalized parts. For example, if the noun phrase was “the actress Nicole Kidman” the variant noun phrase would be “Kidman.” This variant may serve to select last names as a potential complement to the variant discussed above which potentially selects only first names.

Although each of the four examples of variants are shown in FIG. 2 serially, in an example, only one, only two, or only three of the variants may be included.

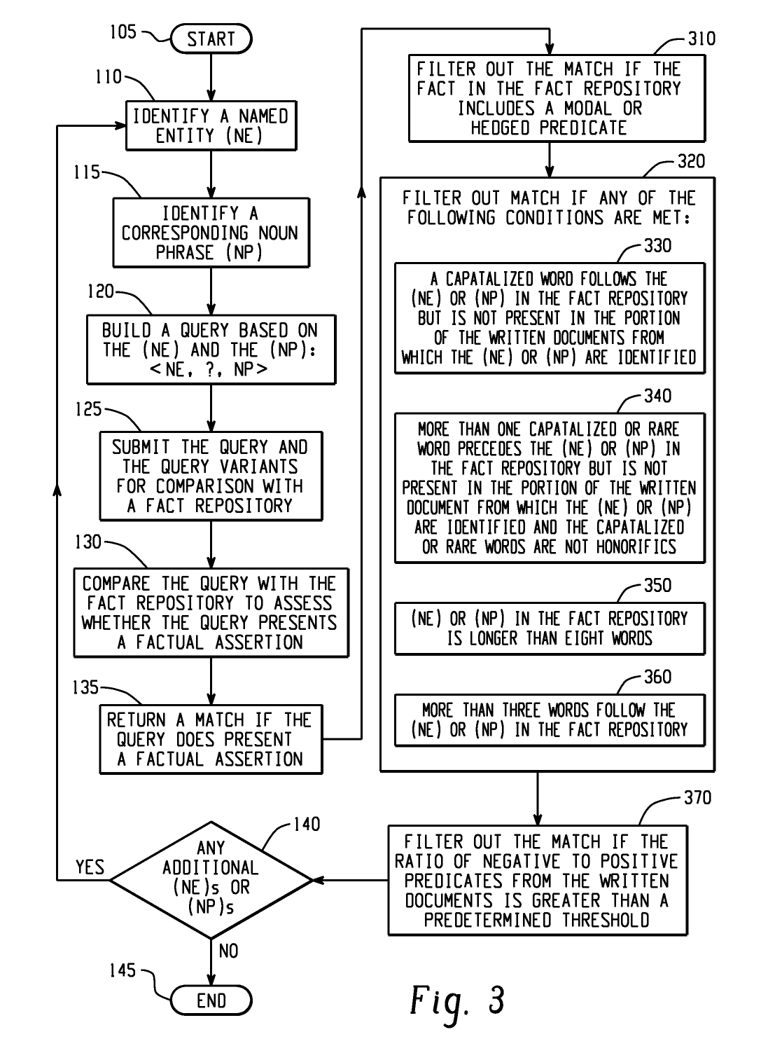

FIG. 3 is a flow diagram illustrating another example of a method for identifying factual information in written documents. FIG. 3 is similar to the example illustrated in FIG. 1 except that an additional series of steps 320-370 are included to filter out potentially undesirable matches from those returned by the comparison with the fact repository 135. The filters illustrated in FIG. 3 may also be combined, for example, with the variants illustrated in FIG. 2. In the example illustrated in FIG. 3, the filtering is performed after each match is returned but could also be performed after some or all of the matches are returned. Filters such as those shown in FIG. 3 may be desirable in examples where matches are returned based on predetermined criteria that potentially yields some undesirable matches.

Matches may be filtered if the fact (e.g., named entity and/or noun phrase) in the fact repository comprises modal or hedged predicates 310. For example, matches based on predicates such as “might turn out to be” or “possibly attended” may be filtered out. Similarly, matches based on future tense predicates may be filtered out as well.

Matches may be filtered if the fact in the fact repository is more specific than the one in the query 320. For example, the match may be filtered if any of the following conditions are met. The match may be filtered if a capitalized word follows the fact in the fact repository but is not present in the sentence (or neighboring sentence) from which the query was identified 330. The match may be filtered if more than one capitalized or rare words precedes the fact in the fact repository but is not present in the sentence (or neighboring sentence) from which the query was identified and the capitalized or rare words are not honorifics 340. The match may be filtered if the fact in the fact repository is longer than eight words 350. The match may be filtered if more than three words follow the fact in the fact repository 360.

Matches may also be filtered if the ratio of negative to positive predicates among a plurality of matches is greater than a predetermined threshold 370. For example, a query such as <Barack Obama, ?, US citizen> may be filtered out based on the following pattern of matches:

| Count | Predicate |
|---|---|
| 10 | is not |
| 4 | is |
| 2 | was always |
| 1 | is really |
| 1 | isn't |
| 1 | was not |

Additionally, matches may be filtered if the matches themselves reflect a lack of consensus and/or an argumentative statement.

Although each of the examples of filters are shown in FIG. 3 serially, in an example, only one or only two of the filters may be included. Additionally, the filters may be configured such that more than one filter needs to be satisfied before a match is filtered out. For example, the filters may be configured such that a match is not filtered out unless the noun phrase comprises a modal or hedged predicate and the fact in the fact repository is more specific than the one in the query.

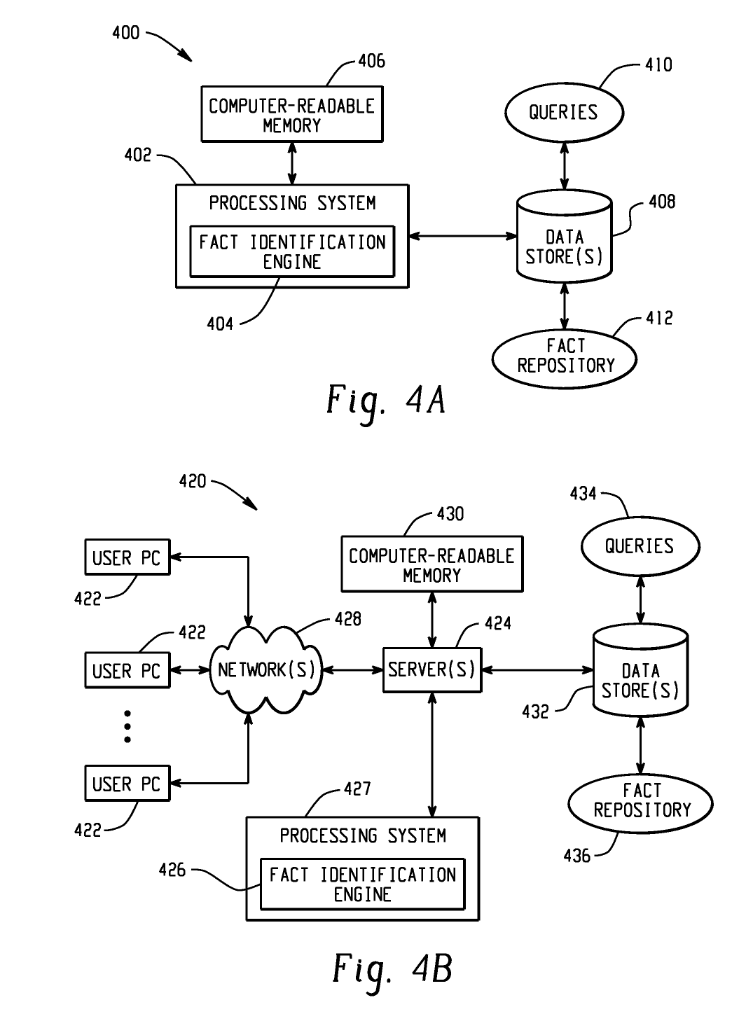

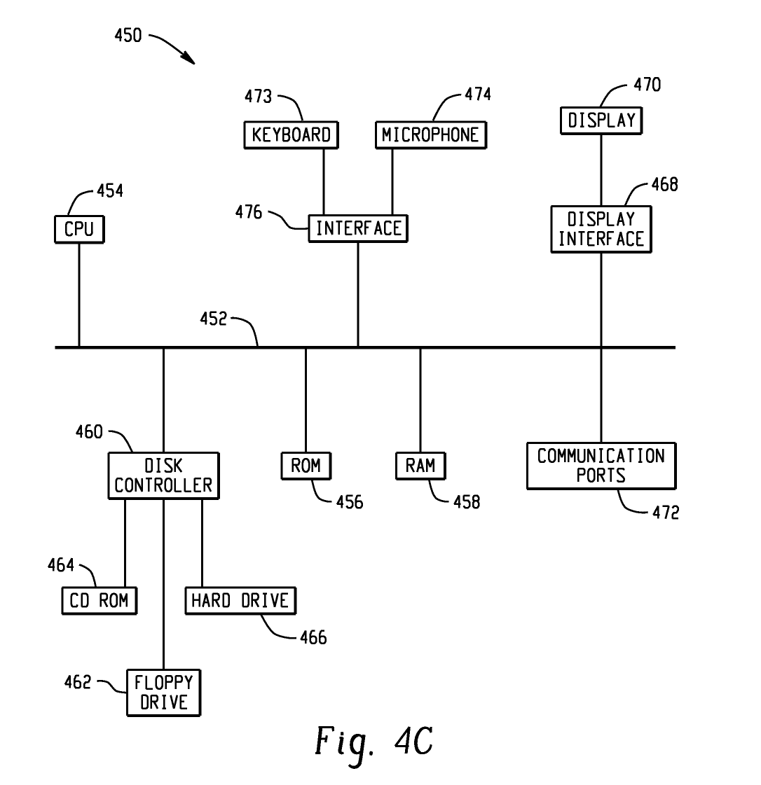

Examples have been used to describe the invention herein and the scope of the invention may include other examples. FIGS. 4A, 4B, and 4C depict example systems for use in implementing recognition of phrasal terms. For example, FIG. 4A illustrates an exemplary system 400 that includes a standalone computer architecture where a processing system 402 (e.g., one or more computer processors located in a given computer or in multiple computers that may be separate and distinct from one another) includes a fact identification engine 404 being executed on it. The processing system 402 has access to at least one computer-readable memory 406 in addition to one or more data stores 408. The one or more data stores 408 may include the queries (and/or written documents) 410 as well as a fact repository 412.

FIG. 4B depicts a system 420 that includes a client server architecture. One or more user PCs 422 access one or more servers 424 running a part of fact recognition engine 426 on a processing system 427 via one or more networks 428. The one or more servers 424 may access a computer readable memory 430 as well as one or more data stores 432. The one or more data stores 432 may contain queries (and/or written documents) 434 as well as a fact repository 436.

FIG. 4C shows a block diagram of exemplary hardware for a standalone computer architecture 450, such as the architecture depicted in FIG. 4A that may be used to contain and/or implement the program instructions of system embodiments of the present invention. A bus 452 may serve as the information highway interconnecting the other illustrated components of the hardware. A processing system 454 labeled CPU (central processing unit) (e.g., one or more computer processors at a given computer or at multiple computers), may perform calculations and logic operations required to execute a program. A non-transitory processor-readable storage medium, such as read only memory (ROM) 456 and random access memory (RAM) 458, may be in communication with the processing system 454 and may contain one or more programming instructions for performing the method of implementing a part of speech pattern scoring engine. Optionally, program instructions may be stored on a non-transitory computer readable storage medium such as a magnetic disk, optical disk, recordable memory device, flash memory, or other physical storage medium.

A disk controller 460 interfaces one or more optional disk drives to the system bus 452. These disk drives may be external or internal floppy disk drives such as 462, external or internal CD-ROM, CD-R, CD-RW or DVD drives such as 464, or external or internal hard drives 466. These various disk drives and disk controllers may be optional devices.

Each of the element managers, real-time data buffer, conveyors, file input processor, database index shared access memory loader, reference data buffer and data managers may include a software application stored in one or more of the disk drives connected to the disk controller 460, the ROM 456 and/or the RAM 458. The processor 454 may access each component as required.

A display interface 468 may permit information from the bus 452 to be displayed on a display 470 in audio, graphic, or alphanumeric format. Communication with external devices may optionally occur using various communication ports 472.

In addition to the standard computer-type components, the hardware may also include data input devices, such as a keyboard 473, or other input device 474, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

While this document uses examples to disclose the inventions described herein, it will be obvious to those skilled in the art that patentable scope of the invention may include other examples as well. It is intended that the following claims define the scope of the invention and that methods and structures within the scope of these claims and their equivalents be covered thereby.

What is claimed is:

1. A computer implemented method for identifying factual information in a written document, the method comprising:
identifying one or more named entities in the written document;
identifying one or more noun phrases in the written document, wherein the one or more noun phrases are associated with a corresponding one or more named entities;
building at least one query by combining one of the one or more named entities with a respective one of the one or more noun phrases, wherein the at least one query corresponds to an assertion;
submitting the at least one query for comparison with a fact repository;
assessing whether the query submitted to the fact repository presents a factual assertion; and
returning a match if the query submitted to the fact repository presents a factual assertion.

2. The method of claim 1, wherein the one or more named entities comprise at least one of people, proper names, locations, organizations, government, awards, events, science and technology, and art.

3. The method of claim 1, wherein the one or more noun phrases are identified from the same sentence as the corresponding one or more named entities.

4. The method of claim 1, wherein the one or more noun phrases are identified from a neighboring sentence to the corresponding one or more named entities.

5. The method of claim 1, wherein the one or more noun phrases are identified from a neighboring sentence to the corresponding one or more named entities only if the corresponding one or more named entity is a person and the neighboring sentence includes at least one of an appropriate personal pronoun and a portion of the named entity.

6. The method of claim 1, wherein the named entities are identified using the Stanford Named Entity Recognizer.

7. The method of claim 1, wherein the fact repository is the world wide web.

8. The method of claim 1, wherein the fact repository is the TextRunner repository.

9. The method of claim 1, wherein the one or more noun phrases are identified using a dependency path.

10. The method of claim 9, wherein the dependency path is an upward step followed by between one and four downward steps.

11. The method of claim 1, wherein the written document is a test taker's essay and the identification of factual information is utilized in the scoring of the test taker's essay.

12. The method of claim 1, further comprising building one or more variants of the at least one query by modifying the one or more noun phrases.

13. The method of claim 12, wherein the modification of the noun phrases comprise:
i. a first variant comprising a sequence of nouns ending with the head noun;
ii. a second variant comprises only the word from the one or more noun phrases that has the lowest frequency of occurrence;
iii. a third variant comprising only the rightmost capitalized word, if the one or more noun phrases includes capitalized parts; and
iv. a fourth variant comprising the removal of determiners and pre-modifiers from the one or more noun phrases.

14. The method of claim 1, further comprising filtering the match if the one or more noun phrases in the fact repository comprises modal or hedged predicates.

15. The method of claim 1, further comprising filtering the match if the one or more named entities or the one or more noun phrases in the fact repository is more specific than the one or more named entities or the one or more noun phrases in the query.

16. The method of claim 1, further comprising filtering the match if at least one of the following conditions are met:
i. a capitalized word follows the one or more named entities or the one or more noun phrases in the fact repository but is not present in the portion of the written document from which the one or more named entities and the one or more noun phrases are identified;
ii. more than one capitalized or rare words precedes the one or more named entities or the one or more noun phrases in the fact repository but is not present in the portion of the written document from which the one or more named entities and the one or more noun phrases are identified and the capitalized or rare words are not honorifics;
iii. one or more named entities or the one or more noun phrases in the fact repository is longer than eight words; and
iv. more than three words follow the one or more named entities or the one or more noun phrases in the fact repository.

17. The method of claim 1, further comprising filtering the match if the ratio of negative to positive predicates among a plurality of matches is greater than a predetermined threshold.

18. A computer implemented system for identifying factual information in a written document, the system comprising:
one or more data processors; and
one or more computer readable mediums encoded with instructions for commanding the one or more data processors to execute a method comprising:
i. identifying one or more named entities in the written document;
ii. identifying one or more noun phrases in the written document, wherein the one or more noun phrases are associated with a corresponding one or more named entities;
iii. building at least one query by combining one of the one or more named entities with a respective one of the one or more noun phrases, wherein the at least one query corresponds to an assertion;
iv. submitting the at least one query for comparison with a fact repository;
v. assessing whether the query submitted to the fact repository presents a factual assertion; and
vi. returning a match if the query submitted to the fact repository presents a factual assertion.

19. The system of claim 18, wherein the one or more noun phrases are identified using a dependency path.

20. The system of claim 19, wherein the dependency path is an upward step followed by between one and four downward steps.

21. The system of claim 18, wherein the written document is a test taker's essay and the identification of factual information is utilized in the scoring of the test taker's essay.

22. The system of claim 18, wherein the one or more data processors further executes building one or more variants of the at least one query by modifying the one or more noun phrases.

23. The system of claim 22, wherein the modification of the noun phrases comprise:
i. a first variant comprising a sequence of nouns ending with the head noun;
ii. a second variant comprises only the word from the one or more noun phrases that has the lowest frequency of occurrence;
iii. a third variant comprising only the rightmost capitalized word, if the one or more noun phrases includes capitalized parts; and
iv. a fourth variant comprising the removal of determiners and pre-modifiers from the one or more noun phrases.

24. The system of claim 18, wherein the one or more data processors further executes filtering the match if the one or more noun phrases in the fact repository comprises modal or hedged predicates.

25. The system of claim 18, wherein the one or more data processors further executes filtering the match if the one or more named entities or the one or more noun phrases in the fact repository is more specific than the one or more named entities or the one or more noun phrases in the query.

26. The system of claim 18, wherein the one or more data processors further executes filtering the match if at least one of the following conditions are met:
i. a capitalized word follows the one or more named entities or the one or more noun phrases in the fact repository but is not present in the portion of the written document from which the one or more named entities and the one or more noun phrases are identified;
ii. more than one capitalized or rare words precedes the one or more named entities or the one or more noun phrases in the fact repository but is not present in the portion of the written document from which the one or more named entities and the one or more noun phrases are identified and the capitalized or rare words are not honorifics;
iii. one or more named entities or the one or more noun phrases in the fact repository is longer than eight words; and
iv. more than three words follow the one or more named entities or the one or more noun phrases in the fact repository.

27. The system of claim 18, wherein the one or more data processors further executes filtering the match if the ratio of negative to positive predicates among a plurality of matches is greater than a predetermined threshold.

28. A computer-readable medium encoded with instructions for commanding a processing system to execute a method for identifying factual information in a written document, the method comprising:
identifying one or more named entities in the written document;
identifying one or more noun phrases in the written document, wherein the one or more noun phrases are associated with a corresponding one or more named entities;
building at least one query by combining one of the one or more named entities with a respective one of the one or more noun phrases, wherein the at least one query corresponds to an assertion;
submitting the at least one query for comparison with a fact repository;
assessing whether the query submitted to the fact repository presents a factual assertion; and
returning a match if the query submitted to the fact repository presents a factual assertion.
